(19) United States
(12) Patent Application Publication
(10) Pub. No.: US 2026/0171727 A1
(43) Pub. Date: Jun. 18, 2026

(54) CONNECTOR

(71) Applicant: SUMITOMO WIRING SYSTEMS, LTD., Mie (JP)

(72) Inventors: Wataru YAMANAKA, Mie (JP); Yusuke ITO, Mie (JP); Takeyoshi OGUMA, Mie (JP)

(21) Appl. No.: 19/356,262

(22) Filed: Oct. 13, 2025

(30) Foreign Application Priority Data
Oct. 16, 2024 (JP) 2024-180879

(51) Int. Cl. H01R 13/6581

(52) U.S. Cl. CPC H01R 13/6581

(57) ABSTRACT

An outer conductor has therein rear spaces open rearward from the outer conductor, at positions rearward of receiving holes that accommodate dielectric bodies. Inner conductors have board connection portions. Among the inner conductors, the board connection portions of the first inner conductor are configured as front board connection portions, and the board connection portions of the second inner conductors are configured as rear board connection portions disposed rearward of the front board connection portions. The rear board connection portions face the rear spaces. A shielding member is disposed between the front board connection portions and the rear board connection portions in the front-rear direction. The front-rear distance from the rear board connection portions to the rear end of the outer conductor is greater than four times the front-rear distance from the front board connection portions to the shielding member.

### CROSS-REFERENCE TO RELATED APPLICATIONS

This application is based on and claims priority from Japanese Patent Application No. 2024-180879, filed on Oct. 16, 2024, with the Japan Patent Office, the disclosure of which is incorporated herein in its entirety by reference.

### TECHNICAL FIELD

The present disclosure relates to a connector.

### BACKGROUND

A connector described in JP 2023-008309 A includes a housing, a shield shell, a front-rear partition plate, outer terminals, guide sleeves, and inner terminals. The housing is fitted to a partner housing. The shield shell is formed by die casting and has an upper wall portion, a pair of side wall portions, a front wall portion, a left-right partition wall portion, and an intermediate wall portion. The shield shell is open rearward and downward. The front-rear partition plate is a rectangular flat metal plate. The front-rear partition plate is attached to the shield shell and divides the internal space of the shield shell into a rear side and a front side. The outer terminals are cylindrical metal tubes and are inserted into terminal receiving holes of the housing. The guide sleeves are made of resin and have a sleeve body portion (referred to as the “body portion” in JP 2023-008309 A) extending in the front-rear direction, and a sleeve hanging portion (referred to as the “hanging portion” in JP 2023-008309 A) extending downward from the rear end portion of the sleeve body portion. The guide sleeves include large guide sleeves (guide sleeves 50A) and small guide sleeves (guide sleeves 50B). The sleeve body portions of the large guide sleeves are inserted into the upper outer terminals. The sleeve body portions of the small guide sleeves are inserted into the lower outer terminals. The inner terminals have a rod-shaped terminal body portion (referred to as the “body portion” in JP 2023-008309 A) extending in the front-rear direction, and a rod-shaped terminal hanging portion (referred to as the “hanging portion” in JP 2023-008309 A) extending downward from the rear end portion of the terminal body portion. The terminal body portions are inserted into the sleeve body portions. The terminal hanging portions are arranged so as to be able to come into contact with the sleeve hanging portions from behind. The tips of the terminal hanging portions are inserted into through holes of a circuit board, and are connected, by soldering, to a conductor pattern of the circuit board. The front and rear terminal hanging portions are respectively disposed in the front and rear spaces separated by the front-rear partition plate in the internal space of the shield shell. JP 2022-083728 A and JP 2020-109738 A also disclose shielded connectors that can be attached to a circuit board, but do not have a member equivalent to the front-rear partition plate described above.

### SUMMARY

In the case of JP 2023-008309 A, the rear end position of the shield shell (i.e., the rear end positions of the upper wall portion and the side wall portions) is separated rearward away from the rear terminal hanging portions. For this reason, it can be estimated that even if the space rearward of the rear terminal hanging portions is open, shielding performance (noise shielding performance) is maintained within an acceptable range. However, compared with the front-rear distance from the front terminal hanging portions to the shielding member, the front-rear distance from the rear terminal hanging portions to the rear end position of the shield shell is smaller, and therefore it can be estimated that it is not possible to ensure shielding performance equivalent to that achieved when the rear surface opening of the shield shell is closed. To address this, it is possible to, for example, close the rear surface opening of the shield shell with a shielding member, but providing the shielding member increases the number of parts.

In view of this, an object of the present disclosure is to provide a connector that enables ensuring shielding performance equivalent to that achieved when the rear surface opening of an outer conductor is closed by a shielding member.

A connector according to an aspect of the present disclosure includes: a plurality of inner conductors; a plurality of dielectric bodies configured to accommodate the plurality of inner conductors; an outer conductor configured to accommodate the plurality of dielectric bodies; and a plate-shaped shielding member, wherein the outer conductor has therein a rear space open rearward from the outer conductor, at a position rearward of a plurality of receiving holes configured to accommodate the plurality of dielectric bodies, each of the inner conductors has a board connection portion extending downward from a rear surface of the corresponding dielectric body, the board connection portion of at least one of the plurality of inner conductors is configured as a front board connection portion, and the board connection portion of at least another one of the plurality of inner conductors is configured as a rear board connection portion disposed rearward of the front board connection portion, the rear board connection portion faces the rear space, the shielding member is disposed between the front board connection portion and the rear board connection portion in the front-rear direction, and a front-rear distance from the rear board connection portion to a rear end of the outer conductor is greater than four times a front-rear distance from the front board connection portion to the shielding member.

According to the present disclosure, it is possible to provide a connector that enables ensuring shielding performance equivalent to that achieved when the rear surface opening of the outer conductor is closed by a shielding member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side cross-sectional view showing a state in which a connector according to a first embodiment is mounted on a circuit board.

FIG. 2 is an exploded perspective view of the connector according to the first embodiment.

FIG. 3 is a perspective view of the connector according to the first embodiment as viewed obliquely from below and behind.

FIG. 4 is an enlarged bottom view showing a structure of the lower surface side of an outer conductor in the connector according to the first embodiment.

FIG. 5 is a rear view of a housing of the connector according to the first embodiment.

FIG. 6 is a front view of the outer conductor of the connector according to the first embodiment.

FIG. 7 is a bottom view of the outer conductor of the connector according to the first embodiment.

FIG. 8 is a rear view of the outer conductor of the connector according to the first embodiment.

FIG. 9 is a cross-sectional view of the connector according to the first embodiment, taken along line A-A in FIG. 8.

FIG. 10 is a transverse sectional view showing a state in which guide portions have come into contact with the inner surfaces of receiving holes in the connector according to the first embodiment.

FIG. 11 is an enlarged transverse sectional view showing a state in which guide portions have been inserted into guide receiving portions, and protrusions have been fitted into recesses, in the process of attaching a dielectric body to the outer conductor of the connector according to the first embodiment.

FIG. 12 is an enlarged partial cutaway side view showing a state in which guide portions have been inserted into guide receiving portions, and protrusions have been fitted into recesses, in the process of attaching the dielectric body to the outer conductor of the connector according to the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### [Description of Embodiments of the Present Disclosure]

First, embodiments of the present disclosure will be listed and described.

(1) A connector according to an aspect of the present disclosure includes: a plurality of inner conductors; a plurality of dielectric bodies configured to accommodate the plurality of inner conductors; an outer conductor configured to accommodate the plurality of dielectric bodies; and a plate-shaped shielding member, wherein the outer conductor has therein a rear space open rearward from the outer conductor, at a position rearward of a plurality of receiving holes configured to accommodate the plurality of dielectric bodies, each of the inner conductors has a board connection portion extending downward from a rear surface of the corresponding dielectric body, the board connection portion of at least one of the plurality of inner conductors is configured as a front board connection portion, and the board connection portion of at least another one of the plurality of inner conductors is configured as a rear board connection portion disposed rearward of the front board connection portion, the rear board connection portion faces the rear space, the shielding member is disposed between the front board connection portion and the rear board connection portion in the front-rear direction, and a front-rear distance from the rear board connection portion to a rear end of the outer conductor is greater than four times a front-rear distance from the front board connection portion to the shielding member.

In this way, the front-rear distance from the rear board connection portion to the rear end portion of the outer conductor is greater than four times the front-rear distance from the front board connection portion to the shielding member, and therefore the shielding performance of the outer conductor can be adjusted so as to be shielding performance equivalent to that achieved when the rear surface opening of the outer conductor is closed by a shielding member (hereinafter referred to as “shielding performance equivalent to rear blocking”). Therefore, there is no need to provide a shielding member to close the rear surface opening behind the rear board connection portion, it is possible to commensurately reduce the number of parts, and it is possible to keep cost low.

(2) In the connector according to (1), it is preferable that the connector further includes a housing to which the outer conductor is attachable, the outer conductor protrudes rearward from the housing, and a front-rear distance from a rear end of the shielding member to the rear end of the outer conductor is greater than a front-rear distance from the front end of the shielding member to a front end of the outer conductor.

According to configuration (2), it is possible to make it easier to adjust the shielding performance of the outer conductor so as to be equivalent to rear blocking, and it is also possible to make it easier to set the center of gravity of the connector to a position on the side where the outer conductor is located. Therefore, for example, when the connector is mounted on a circuit board, the stability of the posture of the connector can be ensured.

(3) In the connector according to (1) or (2), it is preferable that the front-rear distance from the rear board connection portion to a rear end of the outer conductor is greater than six times the front-rear distance from the front board connection portion to the shielding member.

According to configuration (3), the shielding performance of the outer conductor can be reliably set so as to be equivalent to rear blocking.

(4) In the connector according to (3), it is preferable that the front-rear distance from the rear board connection portion to a rear end of the outer conductor is greater than six times and less than seven times the front-rear distance from the front board connection portion to the shielding member.

According to configuration (4), shielding performance equivalent to rear blocking can be obtained without the outer conductor becoming unnecessarily large in the front-rear direction.

### [Details of Embodiments of the Present Disclosure]

Specific examples of the present disclosure will be described below with reference to the drawings. However, the present invention is not limited to these examples, but rather is defined by the claims, and is intended to include all modifications within the meaning and scope of the claims.

### <First Embodiment>

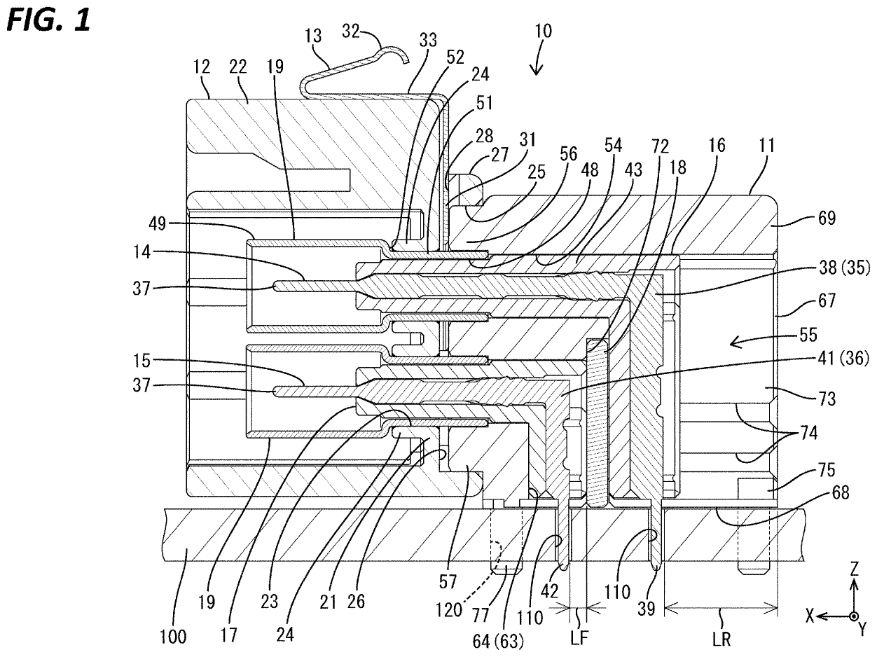

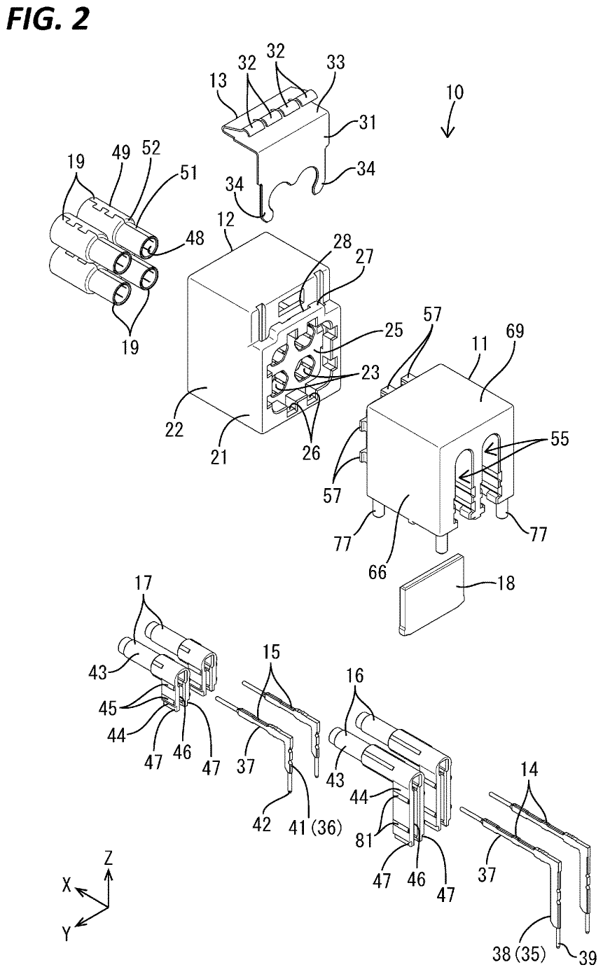

A connector 10 according to a first embodiment is a board connector for mounting on a circuit board 100 as shown in FIG. 1, and is a shielded connector having an outer conductor 11 that has a shielding function. As shown in FIGS. 1 and 2, in addition to the outer conductor 11, the connector 10 is configured to also include a housing 12, a ground connection member 13, inner conductors 14 and 15, dielectric bodies 16 and 17, a shielding member 18, and outer conductor tubes 19. The connector 10 is fitted to a partner connector (not shown). As shown in FIG. 1, the inner conductors 14 and 15 are housed in the dielectric bodies 16 and 17. The dielectric bodies 16 and 17 are housed in the outer conductor 11 and the outer conductor tubes 19. The ground connection member 13 is attached to the housing 12. The shielding member 18 is attached to the outer conductor 11. In the following description, the side of the connector 10 that is fitted to the partner connector in the front-rear direction is defined as the front side. The side of the circuit board 100 on which the connector 10 is mounted in the up-down direction is defined as the upper side. The reference signs X, Y and Z in FIGS. 1 and 2 represent the forward, rightward, and upward directions, respectively. These directional references are merely for convenience and do not necessarily coincide with directional references when the connector 10 is mounted in a vehicle or the like (not shown).

### (Housing 12)

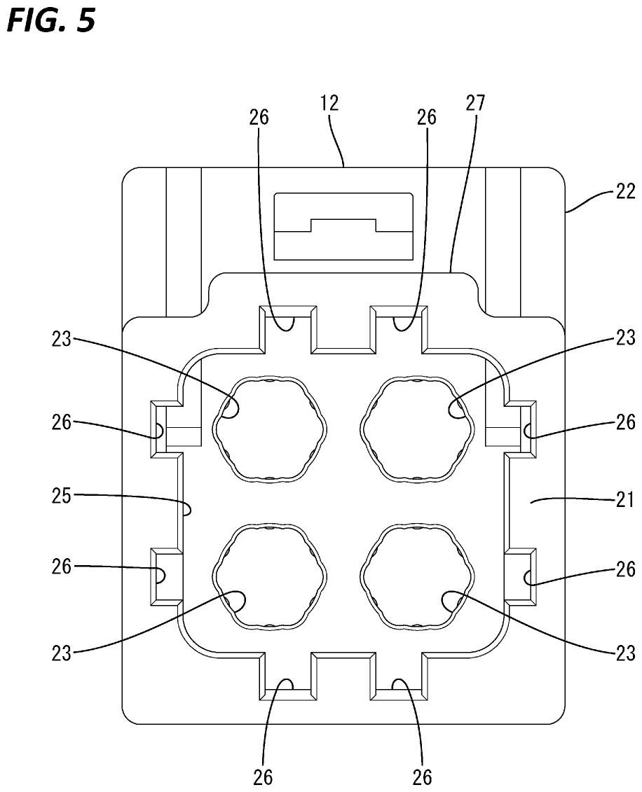

The housing 12 is made of a synthetic resin, and as shown in FIG. 2, overall has a rectangular outer shape. As shown in FIG. 1, the housing 12 has a base wall 21 whose wall surfaces face in the front-rear direction, and a rectangular tube-shaped hood portion 22 that protrudes forward from the base wall 21. A plurality of insertion holes 23 pass through the base wall 21 in the front-rear direction. As shown in FIG. 5, a total of four insertion holes 23 are formed in the base wall 21 in two rows in the vertical direction and two columns in the horizontal direction. Each of the insertion holes 23 has an opening whose shape (cross-sectional shape) corresponds to a nearly-circular regular hexagon with rounded corners when viewed from behind. The outer conductor tubes 19 are inserted into the insertion holes 23 from the front side. As shown in FIG. 1, a plurality of protruding ring portions 24 are formed on the front surface of the base wall 21 and protrude into the hood portion 22. The front end portions of the insertion holes 23 are respectively formed inside the protruding ring portions 24.

As shown in FIG. 5, a fitting recess 25 is formed in the rear surface of the base wall 21. The insertion holes 23 are open at the back surface of the fitting recess 25. A plurality of recessions 26 are formed in the inner peripheral surface of the fitting recess 25 of the base wall 21 and are spaced apart in the peripheral direction. Two recessions 26 are formed in each of the upper, lower, left, and right sides of the inner peripheral surface of the fitting recess 25. Fitting protrusions 56 of the outer conductor 11, which will be described later, are fitted to the fitting recesses 25. Projections 57 of the outer conductor 11, which will be described later, are respectively fitted into the recessions 26.

As shown in FIGS. 1 and 2, the base wall 21 has an upward end surface 27 between the upper end portion of the rear surface of the base wall 21 and the portion having the fitting recesses 25. Although not shown in detail, an attachment groove 28 into which the ground connection member 13 can be attached is formed in the upward end surface 27 of the base wall 21. The attachment groove 28 is shaped as a slit extending in the left-right direction when viewed from above. The lower end of the attachment groove 28 is open at the inner peripheral surface of the fitting recess 25.

### (Ground Connection Member 13)

The ground connection member 13 is constituted by a conductive metal plate. As shown in FIG. 2, the ground connection member 13 has a flat plate-shaped attachment portion 31 whose plate surfaces face in the front-rear direction, and a plurality of elastic contact portions 32 that are elastically deformable and come into contact with a wall surface of a metal housing (ground member) not shown. The ground connection member 13 also has a connecting portion 33 that extends from the upper end of the attachment portion 31 to the base portions of the elastic contact portions 32. The connecting portion 33 has a flat plate shape with plate surfaces facing in the up-down direction. As shown in FIG. 1, the connecting portion 33 is placed on the upper surface of the housing 12. The attachment portion 31 is inserted into the attachment groove 28 of the housing 12 from above and held therein. As shown in FIG. 2, a pair of left and right protrusions 34 are formed on the lower end portion of the attachment portion 31. When the attachment portion 31 is inserted into the attachment groove 28, the protrusions 34 are inside the fitting recess 25 and come into contact with the outer conductor tube 19.

### (Inner Conductors 14, 15)

The inner conductors 14 and 15 are conductive metal members (metal wires) and are formed in the shape of a pin or tab. As shown in FIGS. 1 and 2, the inner conductors 14 and 15 each have a partner connection portion 37 extending in the front-rear direction, and respectively have board connection portions 35 and 36 extending downward from the rear end of the partner connection portions 37. The inner conductors 14 and 15 are L-shaped when viewed from the side. In the case of the first embodiment, the inner conductors include the first inner conductors 14 and the second inner conductors 15 that are shorter than the first inner conductors 14. The partner connection portions 37 of the first inner conductors 14 are longer in the front-rear direction than the partner connection portions 37 of the second inner conductors 15. The board connection portions of the first inner conductors 14 (later-described rear board connection portions 35) are longer in the up-down direction than the board connection portions of the second inner conductors 15 (later-described front board connection portions 36).

As shown in FIG. 1, in the assembled state in which the inner conductors 14 and 15 are housed in the dielectric bodies 16 and 17, and furthermore the dielectric bodies 16 and 17 are housed in the outer conductor 11, the front end portions of the partner connection portions 37 are arranged so as to protrude inside the hood portion 22. When the partner connector is fitted into the hood portion 22, the front end portions of the partner connection portions 37 come into contact with partner inner conductors (not shown) of the partner connector, and the inner conductors 14 and 15 are connected to the partner inner conductors.

The board connection portions (rear board connection portions 35) of the first inner conductors 14 are located rearward of the board connection portions (front board connection portions 36) of the second inner conductors 15 in the assembled state. In the following description, the board connection portions of the first inner conductors 14 are referred to as the “rear board connection portions 35”, and the board connection portions of the second inner conductors 15 are referred to as the “front board connection portions 36”.

The rear board connection portions 35 overall have a shape extending in the up-down direction. The rear board connection portions 35 each have a plate-shaped rear wide portion 38 with plate surfaces facing in the left-right direction, and a pin-like rear board connection body portion 39 that protrudes downward from the lower rear end portion of the rear wide portion 38.

The front board connection portions 36 also overall have a shape extending in the up-down direction. The front board connection portions 36 each have a front wide portion 41 with plate surfaces facing in the left-right direction, and a pin-like front board connection body portion 42 that protrudes downward from the lower rear end portion of the front wide portion 41. As shown in FIG. 1, the rear board connection body portions 39 and the front board connection body portions 42 are inserted into corresponding through holes 110 of the circuit board 100 and connected, by soldering, to conductive portions (not shown) formed on the circuit board 100.

(Dielectric bodies 16, 17)

As shown in FIG. 1, the dielectric bodies 16 and 17 are made of an insulating synthetic resin material, are interposed between the inner conductors 14 and 15 and the outer conductor 11, and serve to provide insulation between the inner conductors 14 and 15 and the outer conductor 11. As shown in FIG. 2, the dielectric bodies 16 and 17 each have a cylindrical tubular portion 43 extending in the front-rear direction and a rectangular column-shaped lead-out portion 44 extending downward from the rear end portion of the tubular portion 43. The dielectric bodies 16 and 17 are L-shaped when viewed from the side. An insertion recess 46 that extends in the up-down direction is formed in the rear surface of the lead-out portion 44.

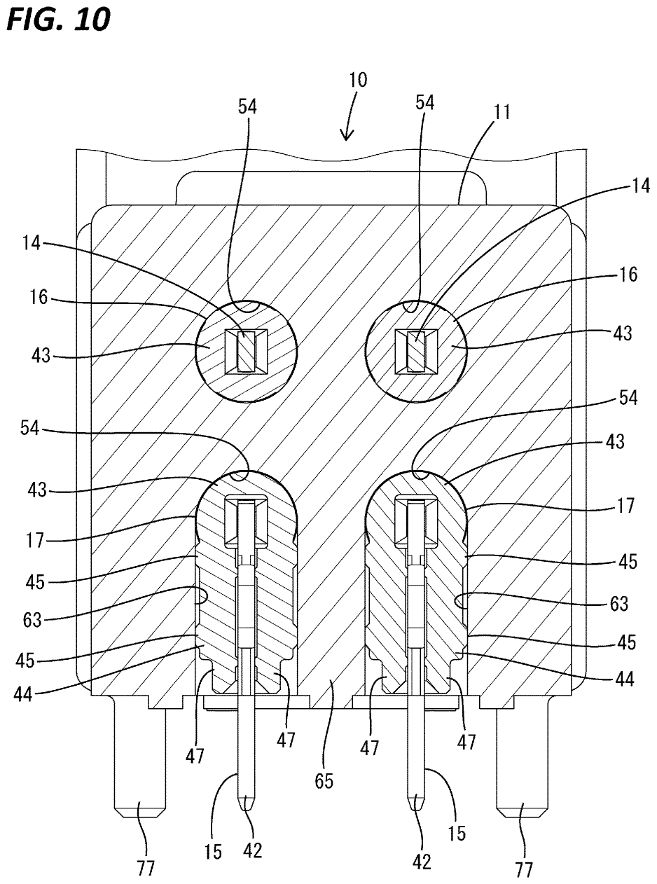

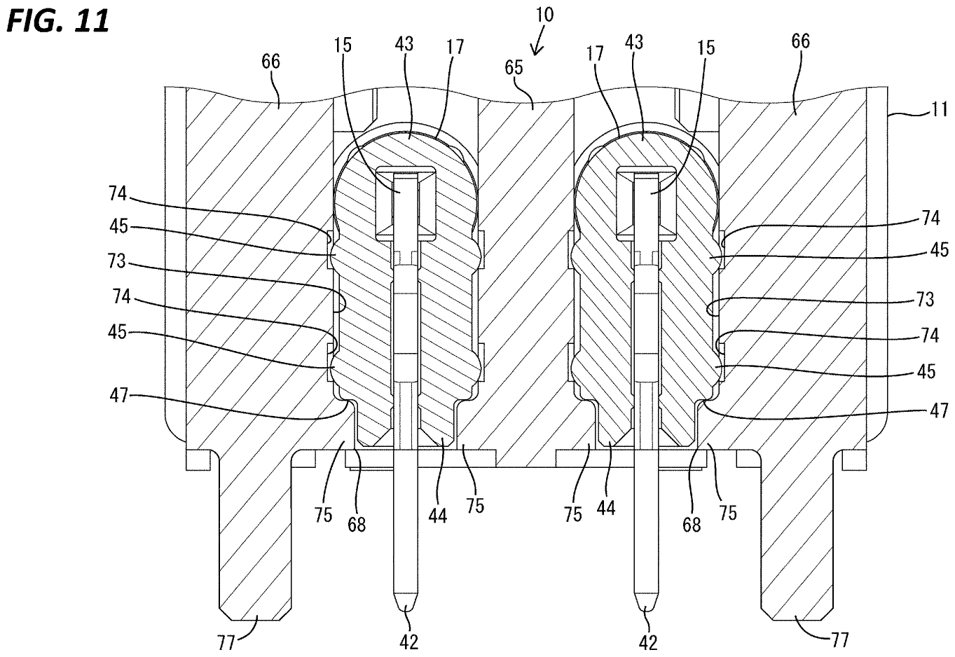

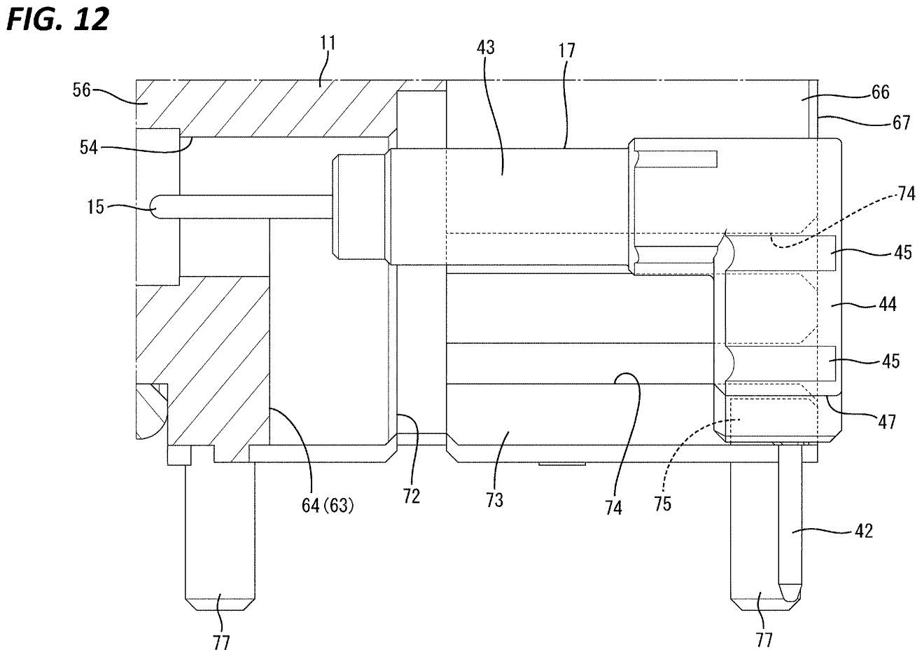

As shown in FIG. 2, guide portions 45 are formed on both the left and right end surfaces of the lead-out portion 44 of each of the second dielectric bodies 17, which will be described later. As shown in FIG. 12, the guide portions 45 are shaped as ribs extending in the front-rear direction, and extend over the entire length of the lead-out portion 44 in the front-rear direction. As shown in FIG. 11, the cross-sectional shape of the guide portions 45 (the shape when cut in a direction perpendicular to the front-rear direction) is a curved shape. The guide portions 45 are formed in pairs on each of the left and right end surfaces of the lead-out portion 44, and are spaced apart in the up-down direction. As shown in FIG. 2, rib-shaped holding portions 81 are formed corresponding to the guide portions 45, on both the left and right end surfaces of the lead-out portion 44 of each of the first dielectric bodies 16, which will be described later. A pair of left and right recesses 47 are formed on the lower end portions of the left and right end surfaces of each of the lead-out portions 44. Each of the recesses 47 is shaped as a groove extending in the front-rear direction, and is open toward the front surface and the rear surface of the lower end portion of the lead-out portion 44. In the case of the first embodiment, as shown in FIG. 10, each of the recesses 47 has a rectangular recess shape in cross-section, such that the lower corner portions on the left and right sides of the lead-out portion 44 are cut away.

The dielectric bodies include the first dielectric bodies 16 and the second dielectric bodies 17 that are shorter than the first dielectric bodies 16. The tubular portions 43 of the first dielectric bodies 16 are longer in the front-rear direction than the tubular portions 43 of the second dielectric bodies 17. The lead-out portions 44 of the first dielectric bodies 16 are longer in the up-down direction than the lead-out portions 44 of the second dielectric bodies 17.

The partner connection portions 37 of the first inner conductors 14 are inserted into the tubular portions 43 of the first dielectric bodies 16 from the rear, such that the front end portions protrude beyond the front end of the tubular portions 43 inside the hood portion 22. Similarly, the partner connection portions 37 of the second inner conductors 15 are inserted into the tubular portions 43 of the second dielectric bodies 17 from the rear, such that the front end portions protrude beyond the front end of the tubular portions 43 inside the hood portion 22.

The rear wide portions 38 of the first inner conductors 14 are inserted, from behind, into the insertion recesses 46 of the lead-out portions 44 of the first dielectric bodies 16. As shown in FIG. 1, the rear board connection body portions 39 of the first inner conductors 14 protrude downward beyond the insertion recesses 46 of the lead-out portions 44 of the first dielectric bodies 16 and are inserted into the corresponding through holes 110. The front wide portions 41 of the second inner conductors 15 are inserted, from behind, into the insertion recesses 46 of the lead-out portions 44 of the second dielectric bodies 17. The front board connection body portions 42 of the second inner conductors 15 protrude downward beyond the insertion recesses 46 of the lead-out portions 44 of the second dielectric bodies 17 and are inserted into the corresponding through holes 110.

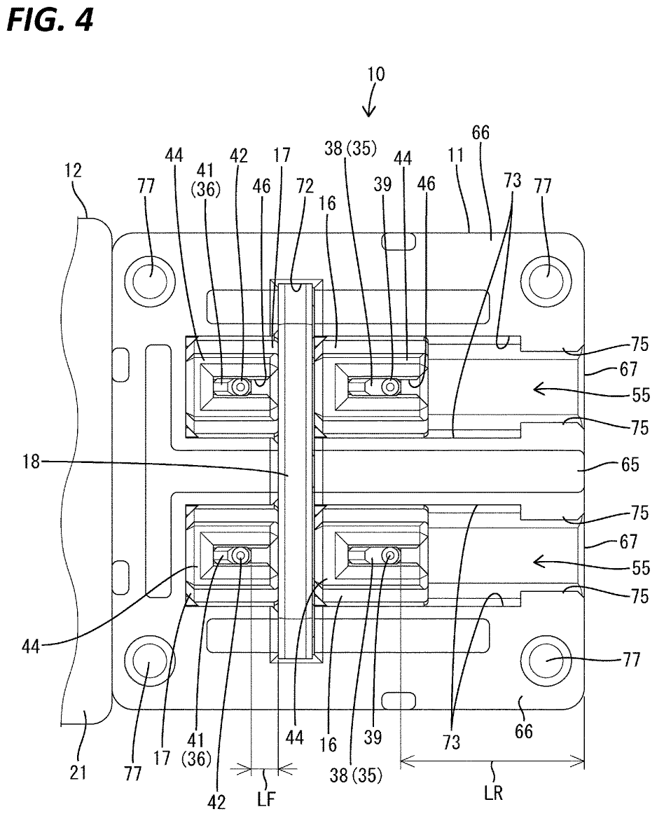

As shown in FIG. 4, when viewed from the bottom in the assembled state, the center axes of the rear board connection body portions 39 of the first inner conductors 14 and the center axes of the front board connection body portions 42 of the second inner conductors 15 are located at the centers of the insertion recesses 46 in the front-rear direction.

### (Shielding Member 18)

The shielding member 18 is a conductive metal plate. As shown in FIG. 2, the shielding member 18 has a rectangular flat plate shape and is disposed with the plate surfaces facing in the front-rear direction. As shown in FIGS. 1 and 4, in the state where the shielding member 18 is attached to the outer conductor 11, the shielding member 18 is disposed between the lead-out portions 44 of the first dielectric bodies 16 and the lead-out portions 44 of the second dielectric bodies 17. The shielding member 18 is disposed behind the front board connection portions 36, which are disposed in the lead-out portions 44 of the second dielectric bodies 17. The shielding member 18 ensures shielding performance behind the first inner conductors 14.

### (Outer Conductor Tubes 19)

The outer conductor tubes 19 are each made of a conductive metal plate, and are formed by bending (pressing) the metal plate into a cylindrical shape. As shown in FIG. 2, each of the outer conductor tubes 19 has a through hole 48 passing through in the front-rear direction. A front portion 49 of the outer conductor tube 19 has a larger diameter than a rear portion 51. The outer conductor tube 19 has a radial step portion 52 between the front portion 49 and the rear portion 51. The rear portion 51 of the outer conductor tube 19 is inserted into the corresponding insertion hole 23 of the housing 12 from the front and is held by the housing 12. As shown in FIG. 1, the step portion 52 abuts against the front end of the corresponding protruding ring portion 24 of the housing 12, and prevents the outer conductor tube 19 from coming out rearward from the housing 12. In the case of the first embodiment, a total of four outer conductor tubes 19 are provided so as to be insertable into the four insertion holes 23, respectively. The outer conductor tubes 19 all have the same shape as each other.

### (Outer Conductor 11)

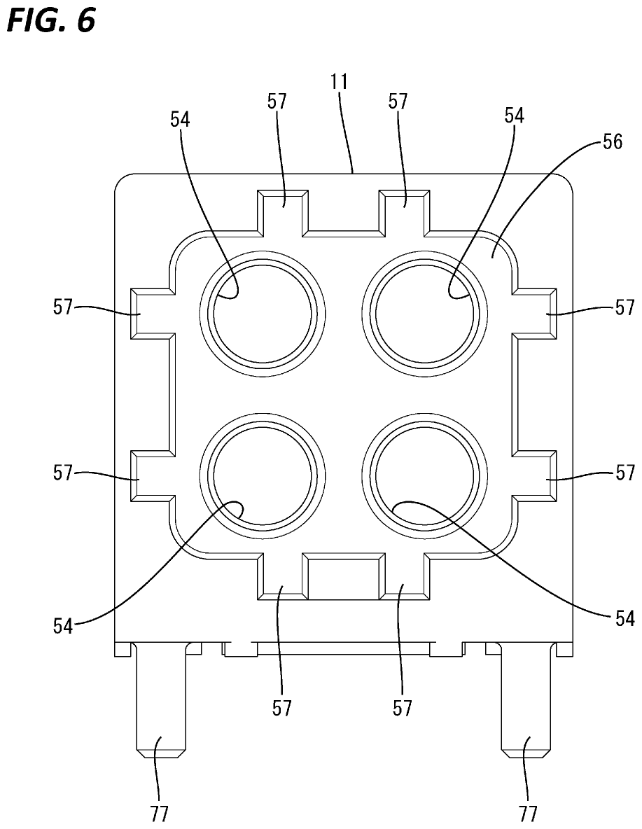

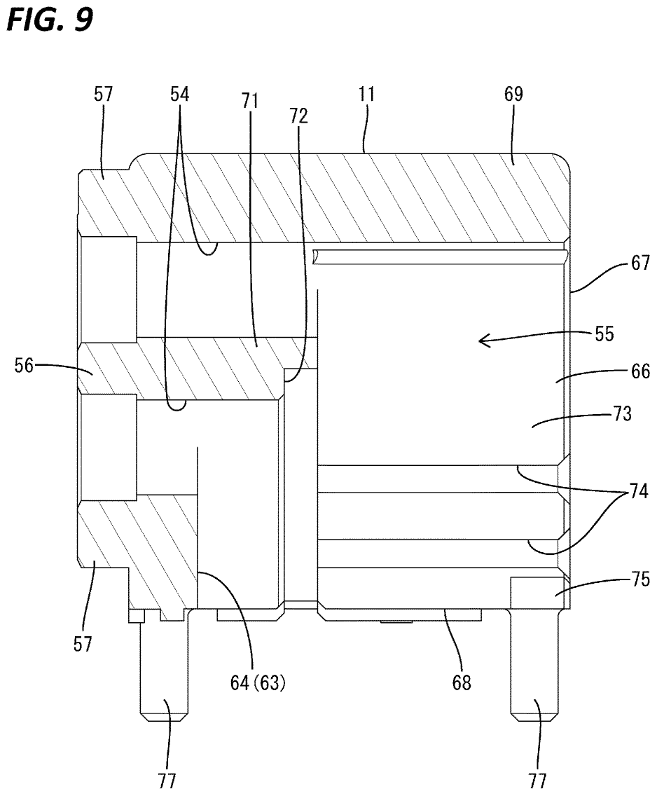

The outer conductor 11 is a conductive rigid body made of die-cast zinc alloy, aluminum alloy, or the like. As shown in FIG. 2, the front surface, rear surface, upper surface, lower surface, and left and right side surfaces of the outer conductor 11 each have a rectangular outer shape. The outer conductor 11 has receiving holes 54 and 63 formed therein. As shown in FIGS. 6 and 9, the receiving holes include body holes 54 that have a circular opening shape (cross-sectional shape) and extend in the front-rear direction. A total of four body holes 54 are formed in the outer conductor 11 in two rows in the vertical direction and two columns in the horizontal direction. As shown in FIG. 9, the front ends of the body holes 54 are open at the front surface of the outer conductor 11, and the rear ends are in communication with rear spaces 55, which will be described later. As shown in FIG. 1, the tubular portions 43 of the corresponding dielectric bodies 16 and 17 are inserted from the rear into the body holes 54 and accommodated therein.

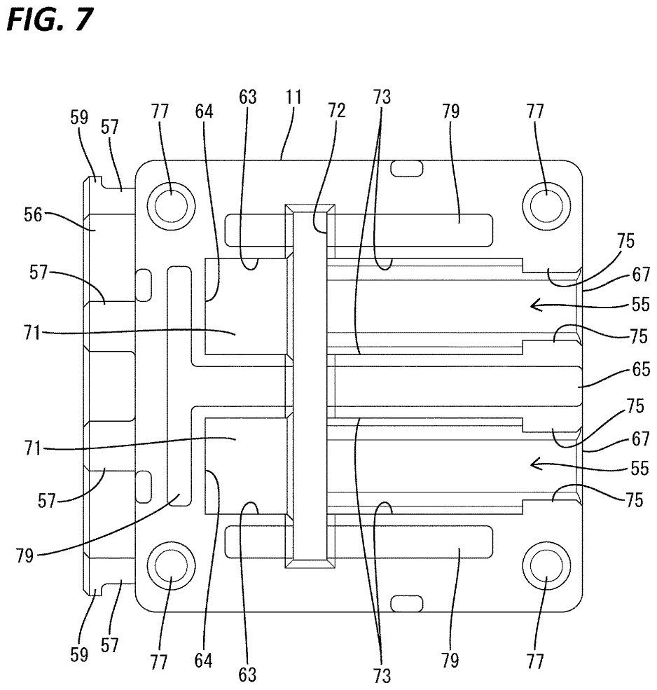

As shown in FIG. 6, a fitting protrusion 56 is formed on the front surface of the outer conductor 11 so as to protrude therefrom. The fitting protrusion 56 has a rectangular shape with rounded corners when viewed from the front. The front surface of the fitting protrusion 56 extends along the up-down direction and the left-right direction. The body holes 54 are open at the front surface of the fitting protrusion 56. A plurality of projections 57 are formed on the outer peripheral surface of the fitting protrusion 56. The projections 57 each have a rectangular shape when viewed from the front, and two projections are provided on each of the upper surface, the lower surface, and the left and right side surfaces of the fitting protrusion 56. As shown in FIG. 7, the projections 57 on the left and right side surfaces each have a locking claw 59. The locking claws 59 protrude slightly laterally outward from the tips, in the protruding direction, of the projections 57.

As shown in FIG. 9, among the body holes 54, the body holes 54 in the upper row are disposed such that the rear end is at or near the center in the front-rear direction of the outer conductor 11, inside the outer conductor 11. The body holes 54 in the lower row are disposed such that the rear end is at a position corresponding to the center in the front-rear direction of the body holes 54 in the upper row, inside the outer conductor 11. The body holes 54 in the upper row receive the tubular portions 43 of the first dielectric bodies 16. The body holes 54 in the lower row receive the tubular portions 43 of the second dielectric bodies 17.

Inside the outer conductor 11, fitting holes 63 are formed as receiving holes. The fitting holes 63 intersect with the rear ends of the body holes 54 in the lower row and extend downward from the body holes 54 in the lower row. The fitting holes 63 are open at the lower surface of the outer conductor 11 and, like the body holes 54, are formed in pairs on each of the left and right sides of a partition wall portion 65, which will be described later. As shown in FIG. 10, the lead-out portions 44 of the second dielectric bodies 17 are inserted into the fitting holes 63 from behind. As shown in FIG. 1, the inner front surfaces of the fitting holes 63 (the surfaces facing rearward on the front side) are configured as front stop surfaces 64 against which the lead-out portions 44 of the second dielectric bodies 17 abut.

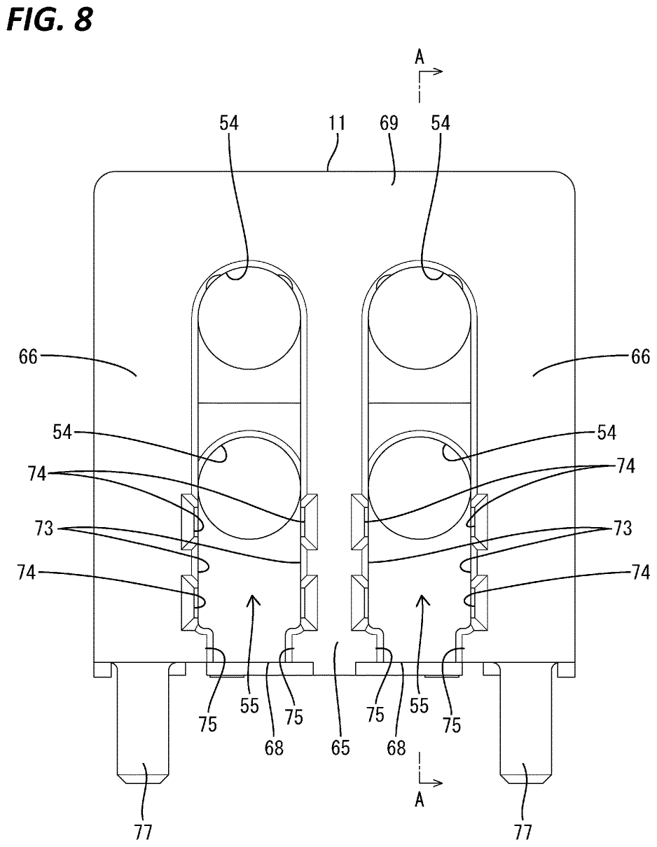

As shown in FIG. 8, a partition wall portion 65 is formed inside the outer conductor 11. The body holes 54 that are adjacent in the left-right direction are separated from each other by the partition wall portion 65. Also, the body holes 54 are defined on the left and right outer sides by side wall portions 66 formed on the left and right sides of the outer conductor 11.

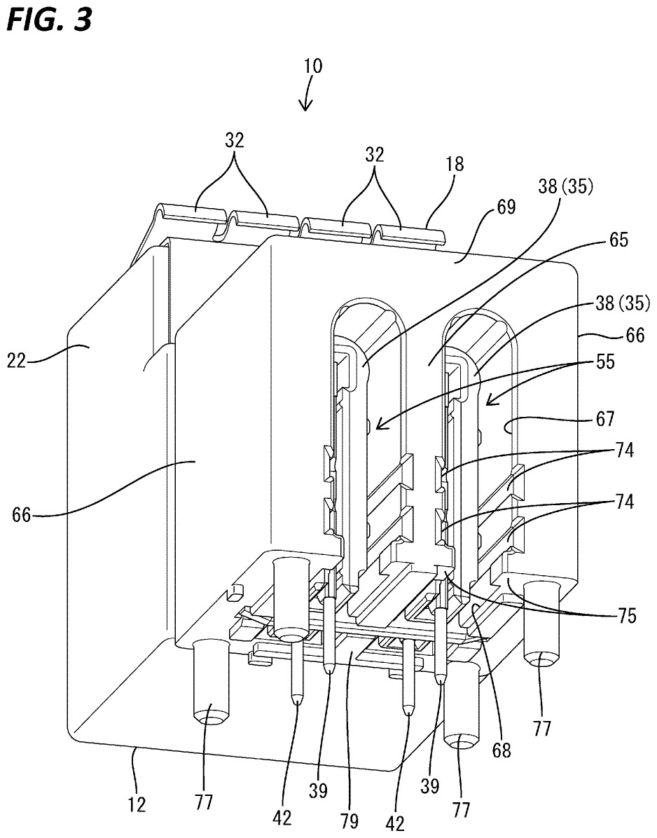

As shown in FIG. 9, inside the outer conductor 11, the rear spaces 55 are formed behind the body holes 54 in the upper row. The rear spaces 55 are open rearward through rear surface openings 67 formed in the rear surface of the outer conductor 11, and are also open downward through lower surface openings 68 formed in the lower surface of the outer conductor 11. In the first embodiment, as shown in FIGS. 3, 4, 7 and 8, two rear spaces 55 are formed in the outer conductor 11 respectively on the left and right sides of the partition wall portion 65. In other words, as shown in FIG. 8, the rear spaces 55 are defined by an upper wall portion 69, side wall portions 66, and the partition wall portion 65 of the outer conductor 11. The outer periphery of the upper end portion of each of the rear spaces 55 is curved in an arch shape extending along the lower surface of the upper wall portion 69.

As shown in FIG. 9, the front-rear length of the rear spaces 55 is longer than or equal to the front-rear length of the body holes 54 in the upper row. Furthermore, as shown in FIGS. 1 and 4, when the connector 10 is in an assembled state, letting LF be the front-rear distance from the rear ends of the front wide portions 41 of the second inner conductors 15 (in the case of the first embodiment, the rearmost ends of the front board connection portions 36) to the front end of the shielding member 18 (in the case of the first embodiment, the front plate surface of the shielding member 18), and LR be the front-rear distance from the rear ends of the rear wide portions 38 of the first inner conductors 14 (in the case of the first embodiment, the rearmost ends of the rear board connection portions 35) to the rear end of the outer conductor 11 (corresponding to the position where the rear surface openings 67 are formed, which, in the case of the first embodiment, corresponds to the rearmost ends of the side wall portions 66), LR is set to be greater than four times LF (4LF<LR). Preferably, LR is set to be greater than five times LF (5LF<LR). More preferably, LR is set to be greater than six times LF (6LF<LR). Even more preferably, LR is set to be greater than 6 times LF and less than 7 times LF (6LF<LR<7LF). In the case of the first embodiment, LR is sufficiently longer than LF, and therefore the outer conductor 11 can ensure high shielding performance.

As shown in FIG. 9, the body holes 54 that are adjacent to each other in the up-down direction are separated by a shelf wall portion 71. As shown in FIG. 7, a slit-shaped holding groove 72 extending in the left-right direction when viewed from the bottom is formed in the outer conductor 11. The holding groove 72 is formed at a position in the front-rear direction corresponding to the rear end portions of the body holes 54 in the lower row. The upper end portion of the holding groove 72 is recessed in the lower surface of the rear end portion of the shelf wall portion 71. Inner surfaces of the left and right side wall portions 66 are provided with recesses such that the left and right end portions of the holding groove 72 extend in the up-down direction. As shown in FIGS. 1 and 4, the shielding member 18 is inserted into the holding groove 72 from below and held therein.

As shown in FIG. 8, the inner surfaces of the side wall portions 66 and the partition wall portion 65 are opposing surfaces 73 that face each other with the rear spaces 55 therebetween. A plurality of guide receiving portions 74 are formed on each of the opposing surfaces 73. As shown in FIGS. 3 and 9, the guide receiving portions 74 are shaped as grooves extending in the front-rear direction on the opposing surfaces 73, with the front ends being in communication with the holding grooves 72, and the rear ends being open rearward through the rear surface openings 67. In short, the guide receiving portions 74 have the same front-rear length as the rear spaces 55. As shown in FIG. 11, each of the guide receiving portions 74 has a rectangular recess shape, in cross-section, that is longer in the up-down direction than in the left-right direction. Also, as shown in FIG. 8, the guide receiving portions 74 are arranged in pairs on the opposing surfaces 73 at the same height in the up-down direction, and are spaced apart from each other in the up-down direction. Until the tubular portions 43 of the second dielectric bodies 17 are fitted to the body holes 54 in the lower row, as shown in FIG. 11, the guide portions 45 of the second dielectric bodies 17 are received in the guide receiving portions 74 so as to be able to come into contact.

As shown in FIGS. 7 and 8, pairs of protrusions 75 are formed on the rear lower end portions of the opposing surfaces 73 of the outer conductor 11. As shown in FIGS. 7 and 9, the protrusions 75 are shaped as short ribs extending in the front-rear direction at the rear lower end portions of the opposing surfaces 73 of the outer conductor 11. The protrusions 75 face the rear surface openings 67 and the lower surface openings 68, and reduce the opening widths thereof in the left-right direction. The left-right distance (minimum opposing distance) between each pair of protrusions 75 is smaller than the left-right thickness of the lower rear end portions (including the protrusions 75) of the partition wall portion 65 and the side wall portions 66. Since the protrusions 75 reduce the opening widths of the rear surface openings 67 and the lower surface openings 68, it is possible to avoid a situation in which, during plating processing, transportation, or the like, outer conductors 11 become entangled with each other due to, for example, the partition wall portion 65 or the side wall portions 66 entering into the rear spaces 55 of another outer conductor. The protrusions 75 are formed only at positions near the rear ends of the opposing surfaces 73. The front ends of the protrusions 75 are set at positions spaced rearward away from the holding grooves 72. Before the dielectric bodies 16 and 17 are inserted into the corresponding body holes 54, the protrusions 75 come into contact with the recesses 47 of the dielectric bodies 16 and 17 in the fitted state.

As shown in FIGS. 3, 4 and 7, four leg portions 77 protrude from the lower surface of the outer conductor 11 at positions close to the four corners. The leg portions 77 are cylindrical and, as shown in FIG. 1, are inserted into fixing holes 120 formed in the circuit board 100 and fixed by soldering. As shown in FIG. 7, a plurality of mounting portions 79 extending along the edges of the rear surface openings 67 are formed on the lower surface of the outer conductor 11. The lower end surfaces of the mounting portions 79 are flat. The lower end surfaces of the mounting portions 79 face the surface of the circuit board 100 so as to be able to come into contact with that surface, and are connected by soldering to a conductive portion for grounding (not shown) formed on the circuit board 100.

### (Operations of Connector 10)

Next, an example of a procedure for assembling the connector 10 will be described. First, the rear portions 51 of the outer conductor tubes 19 are inserted from the front into the insertion holes 23 in the base wall 21 of the housing 12, and the outer conductor tubes 19 are held by the housing 12. Next, the ground connection member 13 is inserted into the attachment groove 28 of the housing 12 from above. The protrusions 34 of the ground connection member 13 come into contact with the outer circumferential surfaces of the outer conductor tubes 19.

Next, the outer conductor 11 is attached to the housing 12 by fitting the fitting protrusion 56 of the outer conductor 11 into the fitting recess 25 of the housing 12. Here, the rear portions 51 of the outer conductor tubes 19 are fitted from the front into the body holes 54 of the fitting protrusion 56 and held therein. The outer conductor 11 is connected to a housing (ground member) (not shown) via the outer conductor tubes 19 and the ground connection member 13.

Additionally, the projections 57 are fitted into the recessions 26. Furthermore, the locking claws 59 of the projections 57 on the left and right sides engage with and bite into the inner surfaces of the corresponding recessions 26. As a result, the outer conductor 11 is held in a state of being prevented from coming out rearward from the housing 12.

Next, the second dielectric bodies 17 are inserted into the body holes 54 in the lower row of the outer conductor 11 from behind. Here, compared with the first dielectric bodies 16, the second dielectric bodies 17 need to travel a longer distance in the rear spaces 55 before being inserted into the body holes 54 in the lower row, and also need to travel beyond the holding groove 72 at the end of the movement process. For this reason, it is difficult to stably maintain the moving posture (insertion posture) of the second dielectric bodies 17 until they have been inserted into the body holes 54 in the lower row. However, in the case of the first embodiment, when the lead-out portions 44 of the second dielectric bodies 17 are inserted into the rear spaces 55, as shown in FIGS. 11 and 12, the guide portions 45 of the second dielectric bodies 17 are fitted into the guide receiving portions 74 of the outer conductor 11 and can slide along the inner surfaces of the guide receiving portions 74, thereby guiding the movement of the second dielectric bodies 17 toward the body holes 54 in the lower row. In particular, since the front-rear length of the guide portions 45 is greater than the front-rear groove width of the holding groove 72, the guide portions 45 can pass over the holding groove 72 without getting caught on the groove surfaces of the holding groove 72. Therefore, the moving posture of the second dielectric bodies 17 is unlikely to be disturbed, and the tubular portions 43 of the second dielectric bodies 17 can be inserted into the body holes 54 in the lower row quickly and stably. Furthermore, when the lead-out portions 44 of the second dielectric bodies 17 are inserted into the rear spaces 55, the protrusions 75 of the outer conductor 11 are fitted into the recesses 47 of the second dielectric bodies 17, such that the second dielectric bodies 17 are supported by the protrusions 75, thereby making it possible to reliably suppress disturbance of the moving posture of the second dielectric bodies 17.

When the tubular portions 43 of the second dielectric bodies 17 are properly inserted into the body holes 54 in the lower row, the front portions of the tubular portions 43 are fitted into the through holes 48 of the rear portions 51 of the outer conductor tubes 19. Also, the lead-out portions 44 of the second dielectric bodies 17 are fitted to the fitting holes 63, and the front surfaces of the lead-out portions 44 are arranged so as to be able to come into contact with the front stop surfaces 64 of the fitting holes 63. As shown in FIG. 11, the guide portions 45 of the second dielectric bodies 17 are press-fitted (may be squashed) against the left and right inner end surfaces (inner surfaces) of the fitting holes 63 to come into close contact with them. As a result, the second dielectric bodies 17 are stably held by the outer conductor 11.

Before or after the timing when the second dielectric bodies 17 are mounted to the outer conductor 11, the second inner conductors 15 are housed in the second dielectric bodies 17. The partner connection portions 37 of the second inner conductors 15 are inserted into the tubular portions 43, and the front board connection portions 36 of the second inner conductors 15 are inserted into the insertion recesses 46 of the lead-out portions 44 of the second dielectric bodies 17.

Next, the shielding member 18 is inserted into the holding groove 72 of the outer conductor 11 from below. The shielding member 18 is press-fitted into the holding groove 72 of the outer conductor 11 and held therein. The front surface of the shielding member 18 faces the rear surfaces of the lead-out portions 44 of the second dielectric bodies 17 at a distance rearward from the front wide portions 41 of the second inner conductors 15 and can come into contact with the rear surfaces. The rear surface of the shielding member 18 is disposed at the same front-rear position as the rear end of the shelf wall portion 71.

Next, the first dielectric bodies 16 are inserted into the body holes 54 in the upper row of the outer conductor 11 from behind. As shown in FIG. 1, when the tubular portions 43 of the first dielectric bodies 16 are properly inserted into the body holes 54 in the upper row, the front portions of the tubular portions 43 are fitted into the through holes 48 of the rear portions 51 of the outer conductor tubes 19, similarly to the second dielectric bodies 17. The lead-out portions 44 of the second dielectric bodies 17 are disposed in the front end portions of the rear spaces 55 so as to be able to come into contact with the rear surface of the shielding member 18. Then, the holding portions 81 of the first dielectric bodies 16 are pressed-fitted (may be squished) against the opposing surfaces 73 of the outer conductor 11 and come into close contact therewith, and the first dielectric bodies 16 are held by the outer conductor 11. Before or after the timing when the first dielectric bodies 16 are mounted to the outer conductor 11, the first inner conductors 14 are housed in the first dielectric bodies 16. The partner connection portions 37 of the first inner conductors 14 are inserted into the tubular portions 43, and the rear board connection portions 35 of the first inner conductors 14 are inserted into the insertion recesses 46 of the lead-out portions 44 of the first dielectric bodies 16. The front portions of the lead-out portions 44 of the second dielectric bodies 17 (the portions in front of the insertion recesses 46) are disposed between the rear board connection portions 35 of the first inner conductors 14 and the shielding member 18.

Then, the leg portions 77 are inserted into the fixing holes 120, the front board connection body portions 42 of the second inner conductors 15 are inserted into the corresponding through holes 110, and the rear board connection body portions 39 of the first inner conductors 14 are inserted into the corresponding through holes 110. Then, the connector 10 is mounted on the circuit board 100 by performing a soldering process such as reflow soldering.

The inventors measured the shielding attenuation of several types of the connectors, including the connector 10, in accordance with the international standard IEC 62153-4-7. As a result, as already mentioned, it was found that if the front-rear distance LR from the rear ends of the rear board connection portions 35 of the first inner conductors 14 to the rear end (rear surface openings 67) of the outer conductor 11 is greater than four times the front-rear distance LF from the rear ends of the front board connection portions 36 of the second inner conductors 15 to the front end of the shielding member 18 (4LF<LR), it is possible to obtain shielding performance equivalent to that achieved when the rear surface opening of the outer conductor 11 is closed with a blocking member such as a shielding member (hereinafter referred to as “shielding performance equivalent to rear blocking”). In particular, it was found that if LR is greater than six times LF, the shielding attenuation is the same as or less than the shielding attenuation calculated when the rear surface opening of the shielding member 18 is shielded by the shielding member 18. It was also confirmed that the shielding attenuation reaches a plateau when LR is greater than seven times LF. Accordingly, it was found that, as shown in FIGS. 1 and 4, when the front-rear distance (LR) from the rear board connection portions 35 to the rear end of the outer conductor 11 is more than six times and less than seven times the front-rear distance (LF) from the front board connection portions 36 to the shielding member 18, shielding performance equivalent to rear blocking can be obtained without the outer conductor 11 becoming unnecessarily large in the front-rear direction, and such a configuration is preferable.

Also, in the first embodiment, the front-rear distance from the rear end of the shielding member 18 to the rear end of the outer conductor 11 is set to be greater than the front-rear distance from the front end of the shielding member 18 to the front end of the outer conductor 11. In short, inside the outer conductor 11, the shielding member 18 is disposed forward of the center in the front-rear direction of the outer conductor 11. This makes it easier to adjust the shielding performance of the outer conductor 11 so as to be equivalent to rear blocking, and also makes it easier to set the center of gravity of the connector 10 to a position on the side where the outer conductor 11 is located. Therefore, when the connector 10 is mounted on the circuit board 100, the stability of the posture of the connector 10 can be ensured.

Furthermore, in the first embodiment, in the outer conductor 11, the protrusions 75 that protrude so as to narrow the left-right opening widths of the rear surface openings 67 and the lower surface openings 68 are provided at the rear lower end portions of the opposing surfaces 73 (inner surfaces) that face the rear spaces 55. According to this configuration, for example, when a plating process is performed and a plurality of outer conductors 11 are placed in a barrel (not shown), the protrusions 75 of one outer conductor 11 interfere with, for example, the partition wall portion 65 or the side wall portions 66 of another outer conductor 11, thereby suppressing the case where the other outer conductor 11 enters the rear spaces 55 of the one outer conductor 11, and therefore it is possible to prevent the outer conductors 11 from becoming entangled with each other.

Also, the protrusions 75 are configured to come into contact with, from below, the dielectric bodies 16 and 17 moving in the rear spaces 55. As a result, it is possible to suppress the case where the dielectric bodies 16 and 17 fall downward from the rear spaces 55 during movement.

The protrusions 75 are configured to be fitted into the recesses 47 formed in the outer surfaces of the dielectric bodies 16 and 17 moving in the rear spaces 55. As a result, the dielectric bodies 16 and 17 can move smoothly in the rear spaces 55 without rattling in the left-right direction.

The protrusions 75 are provided only at the rear lower end portions of the opposing surfaces 73 of the outer conductor 11, at positions spaced rearward away from the board connection portions 35 and 36. According to this configuration, it is possible to prevent the board connection portions 35 and 36 from becoming electrically connected to the protrusions 75, and it is easier to avoid a situation in which the outer conductor 11 becomes electrically connected to the inner conductors 14 and 15.

Furthermore, according to the first embodiment, the second dielectric bodies 17 have the guide portions 45, and the opposing surfaces 73 (inner surface) of the outer conductor 11 that face the rear spaces 55 have the guide receiving portions 74 that receive the guide portions 45 and guide the tubular portions 43 of the second dielectric bodies 17 to the body holes 54 (receiving holes). According to this configuration, the tubular portions 43 of the second dielectric bodies 17 can smoothly enter the corresponding body holes 54 during the process of mounting the second dielectric bodies 17 to the outer conductor 11.

In particular, the guide receiving portions 74 are shaped as grooves extending in the front-rear direction on the opposing surfaces 73 of the outer conductor 11, and the guide portions 45 are shaped as ribs extending in the front-rear direction on the outer surfaces of the second dielectric bodies 17. When the second dielectric bodies 17 are housed in the outer conductor 11, the guide portions 45 are held in contact with the inner surfaces of the fitting holes 63 (receiving holes). Therefore, the guide portions 45 can have both a function of guiding the second dielectric bodies 17 to the body holes 54 and a function of holding the second dielectric bodies 17 in the outer conductor 11.

Also, the plate-shaped shielding member 18 is disposed between the front board connection portions 36 and the rear board connection portions 35. The outer conductor 11 has the holding groove 72 configured to hold the shielding member 18. The holding groove 72 is in communication with the rear spaces 55. The front-rear length of the guide portions 45 exceeds the front-rear groove width of the holding groove 72. According to this configuration, the state of contact between the guide portions 45 and the guide receiving portions 74 can be maintained until the tubular portions 43 of the second dielectric bodies 17 enter the corresponding body holes 54. This makes it possible to avoid a situation in which the guide portions 45 become caught on the groove surfaces of the holding groove 72, and enables the guide portions 45 to smoothly enter the corresponding body holes 54.

### [Other Embodiments of Present Disclosure]

The above-described first embodiment disclosed herein should be considered as illustrative in all respects and not restrictive.

In the case of the first embodiment, the board connection portions 35 and 36 of the four inner conductors 14 and 15 are arranged side by side in the front-rear direction and the left-right direction in a bottom view of the outer conductor 11. In contrast to this, according to another embodiment, the board connection portions 35 and 36 of two inner conductors may simply be arranged side by side in the front-rear direction in a bottom view of the outer conductor.

In the case of the first embodiment, the outer conductor 11 is formed separately from the outer conductor tubes 19. In contrast, according to another embodiment, the outer conductor may be integrated with the outer conductor tubes. For example, the outer conductor may be a die-cast member integrated with tubular portions corresponding to the outer conductor tubes.

In the case of the first embodiment, the rear spaces 55 are formed respectively on the left and right sides of the partition wall portion 65 in the outer conductor 11. In contrast to this, according to another embodiment, only one rear space may be formed between the pair of side wall portions inside the outer conductor. Furthermore, a plurality of partition wall portions may be formed in the outer conductor, and three or more rear spaces may be formed between the side wall portions and the partition wall portions and between adjacent partition wall portions.

In the case of the first embodiment, the rear spaces 55 are formed respectively on the left and right sides of the partition wall portion 65 in the outer conductor 11. In contrast, according to another embodiment, only one rear space may be formed between the pair of side wall portions inside the outer conductor. Furthermore, in the case where a plurality of partition wall portions are formed in the outer conductor, three or more rear spaces may be formed between the side wall portions and the partition wall portions and between adjacent partition wall portions.

In the case of the first embodiment, the guide portions 45 protrude from the outer surfaces of the dielectric bodies 17, and the guide receiving portions 74 are recessed in the opposing surfaces 73 of the outer conductor 11. In contrast, according to another embodiment, contrary to the first embodiment, the guide portions may be recessed in the outer surfaces of the dielectric bodies, and the guide receiving portions may protrude from the opposing surfaces of the outer conductor.

In the case of the first embodiment, the lower surfaces of the protrusions 75 are located at the lower end surface (lower surface openings 68) of the outer conductor 11, and the rear surfaces of the protrusions 75 are located at the rear end surface (rear surface openings 67) of the outer conductor 11. In contrast to this, in another embodiment, the lower surfaces of the protrusions may be located above the lower end surface of the outer conductor, and the rear surfaces of the protrusions may be located forward of the rear end surface of the outer conductor.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a plurality of inner conductors;
a plurality of dielectric bodies configured to accommodate the plurality of inner conductors;
an outer conductor configured to accommodate the plurality of dielectric bodies; and
a plate-shaped shielding member,
wherein the outer conductor has therein a rear space open rearward from the outer conductor, at a position rearward of a plurality of receiving holes configured to accommodate the plurality of dielectric bodies,
each of the inner conductors has a board connection portion extending downward from a rear surface of the corresponding dielectric body,
the board connection portion of at least one of the plurality of inner conductors is configured as a front board connection portion, and the board connection portion of at least another one of the plurality of inner conductors is configured as a rear board connection portion disposed rearward of the front board connection portion,
the rear board connection portion faces the rear space,
the shielding member is disposed between the front board connection portion and the rear board connection portion in the front-rear direction, and
a front-rear distance from a rear end of the rear board connection portion to a rear end of the outer conductor is greater than four times a front-rear distance from a rear end of the front board connection portion to a front end of the shielding member.

2. The connector according to claim 1, further comprising:
a housing to which the outer conductor is attachable,
wherein the outer conductor protrudes rearward from the housing, and
a front-rear distance from a rear end of the shielding member to the rear end of the outer conductor is greater than a front-rear distance from the front end of the shielding member to a front end of the outer conductor.

3. The connector according to claim 1,
wherein the front-rear distance from the rear end of the rear board connection portion to a rear end of the outer conductor is greater than six times the front-rear distance from the rear end of the front board connection portion to the front end of the shielding member.

4. The connector according to claim 3,
wherein the front-rear distance from the rear end of the rear board connection portion to a rear end of the outer conductor is greater than six times and less than seven times the front-rear distance from the rear end of the front board connection portion to the front end of the shielding member.
